(19) United States
(12) Patent Application Publication
(10) Pub. No.: US 2012/0311594 A1
(43) Pub. Date: Dec. 6, 2012

(54) PROGRAM, DEVICE, AND METHOD FOR BUILDING AND MANAGING WEB SERVICES

(75) Inventor: Shigeru Hosono, Tokyo (JP)

(73) Assignee: NEC CORPORATION, Tokyo (JP)

(21) Appl. No.: 13/577,073

(22) PCT Filed: Jan. 20, 2011
(86) PCT No.: PCT/JP2011/051533

§ 371 Date: Aug. 3, 2012

(30) Foreign Application Priority Data
Feb. 5, 2010 (JP) 2010-024453

(51) Int. Cl. G06F 9/46

(52) U.S. Cl. 718/102

(57) ABSTRACT

A device (100) for performing a method of building and managing a Web service includes: means (111) for creating information on a service non-functional requirement; means (129) for storing information on a group of combinable implemented functions; means (112) for creating information on a logical model for implementing the service non-functional requirement; means (113) for generating program group which realizes the logical model based on the information on the logical model, and which includes the group of combinable implemented functions; means (121) for storing the information on the service non-functional request; means (122) for storing the program group; means (123) for interpreting the non-functional requirement and selecting the group of combinable implemented functions to configure an execution program from the program group; and means (125) for executing the execution program.

### TECHNICAL FIELD

This invention relates to building and running of highly scalable Web services based on non-functional requirements, and more particularly, to a method, device, and program for building and managing such Web services.

### BACKGROUND ART

Conventionally, providers of cloud services such as Software as a Service (SaaS), Platform as a Service (PaaS), and Infrastructure as a Service (IaaS) provide service functions of a Web service function layer, a Web service platform layer, and an operating system layer. A user keeps in mind the mechanism of the system platform in determining which layer's function to use.

Data processing by corporate systems includes a search of the Internet service blog information or word-of-mouth information on the Internet and the accumulation and processing of sensor information of ubiquitous equipment, and the prospect of corporate systems handling a huge amount of data in the future is growing. These types of data have a potential for increasing explosively in a short period of time during the steady operation of the system. A person in charge of system integration is therefore required to design a system that takes into consideration not only the conventional scale-up of an on-premises system (internal corporate system) but also scale-out.

In order to satisfy these requirements, an attempt to reduce processing load has been made by giving a system a multiplex structure in response to a small change in data amount. A huge amount of data or a considerable change in data amount has been dealt with by dynamically changing system execution nodes through grid computing.

However, changes in data amount that occur while a conventional system is in operation are within a range that can be predicted at the time the system is designed. Conventional systems are therefore not designed to be changed dynamically in configuration while in operation with the use of these different load distribution and parallel processing mechanisms.

Model-driven programming and model-driven architecture (MDA) as those described in Japanese Unexamined Patent Application Publication (JP-A) No. 2004-280809 provide a mechanism in which a developer writes a logical structure and a source code is generated automatically from a model. This is intended for components of a Web application and Web 3-tier architecture, and does not allow distributed execution to be configured from a logical model or controlled in the execution environment of an application such as a Web server or at the OS level, which is a further lower layer.

Japanese Unexamined Patent Application Publication (JP-A) No. 2005-310171 deals with a computer-readable program for controlling a computer to perform program generating processing. The program controls a computer to execute: a conversion program generating step of generating a conversion program which performs conversion processing for converting, based on a first element tree which indicates relations of a plurality of elements constituting an interface definition of a Web service, input/output data processible by a function that executes the Web service, and the data type of a value contained in request and response messages relevant to the Web service; and an analysis program generating step of generating an analysis program which analyzes the request message relevant to the Web service and also generates the response message.

Japanese Unexamined Patent Application Publication (JP-A) No. 2007-305051 discloses a system for assisting in writing software requirement specifications. The system includes a server 7 provided with a requirement specifications template table for storing templates of requirement specifications, a product system table for storing data that indicates whether to use an existing product system as a form, a requirement specifications data table for storing data of requirement specifications, a blank item extraction processing portion which performs processing of extracting an item that has not been filled out, a requirement specifications input/display processing portion which performs processing of inputting and displaying specifics to be written in requirement specifications, and a function/non-function association processing portion which performs processing of extracting non-functional requirement items to be written and considered from input functional requirements of a system that is being developed, and setting the extracted items as items to be written in the requirement specifications. A client accesses the server to input requirement items.

Japanese Unexamined Patent Application Publication (JP-A) No. 2008-305079 discloses a method of automatically examining requirement specifications. In the method, a client user fills out necessary items on a requirement specification writing screen and uploads requirement specifications to store in a requirement specifications file, an execution model generation processing portion is activated by an instruction from the user, follows a processing flow to extract item data relevant to the execution model generation from the requirement specifications file, refers to a template in a template file that is necessary for execution model generation, further refers to a dictionary in a dictionary file about item data that needs to be converted in generating an execution model, automatically generates an execution model, and stores in an execution model file, and an examination processing portion extracts data necessary for examination processing from the execution model file and extracts necessary data from the requirement specifications file as well to perform examination.

Focusing on conventional program generating devices alone, Japanese Unexamined Patent Application Publication (JP-A) No. 2003-330710 discloses a configuration of a program generating device which includes an XML processing scheme selecting unit for inputting a desired processing scheme, a component providing unit for acquiring, from a predetermined storage, information concerning components that can be used to generate a predetermined program based on the input processing scheme, a control information definition unit for displaying all or a part of the acquired information in order to input information concerning components for generating the predetermined program based on the displayed information, and a program generating unit for generating the predetermined program based on the input information concerning the components.

### DISCLOSURE OF THE INVENTION

### Problem to be Solved by the Invention

It is difficult with conventional technologies to build a system that satisfies performance and other system requirements in a situation where the magnitude of increase and the degree of change in the amount of data to be handled cannot be predicted at the time the system is designed, in other words, cases where the amount of data such as requests and other types of data to be processed and data to be kept increases explosively while the system is in operation. Conventional technologies also have difficulties in providing steady operation for a system implemented under the situation described above.

This invention has been made in view of these circumstances, and a technical object of this invention is to provide, to persons who engage in building systems, a method, device, and program for building a Web service, which is capable of building a system that satisfies performance and other system requirements even in a situation where the magnitude of increase and the degree of change in the amount of data to be handled cannot be predicted at the time the system is designed.

Another technical object of this invention is to provide, to persons who engaging in operating systems, a method, device, and program for managing a Web service, which is capable of providing steady operation for a system implemented under the situation described above. Means to Solve the Problem

In order to solve the above-mentioned problems, according to an aspect of this invention, there is provided a method of building and managing a Web service, including: a service non-functional requirement describing step of creating service non-functional requirement information based on a non-functional requirement; an implemented function group storing step of storing information on a group of combinable implemented functions that can be combined based on the non-functional requirement; a service logical model describing step of creating information on a service logical model for satisfying the non-functional requirement; a program group generating step of generating a program group which realizes the service logical model based on the information on the service logical model, and which includes the non-functional requirement and the group of combinable implemented functions based on the information on the group of combinable implemented functions; a non-functional requirement storing step of storing the service non-functional requirement information; a program group storing step of storing the program group; an execution program configuring step of interpreting the non-functional requirement and selecting the group of combinable implemented functions to configure an execution program from the program group; and a service executing step of executing the execution program.

According to another aspect of this invention, there is provided a device for building and managing a Web service, including: service non-functional requirement describing means for creating service non-functional requirement information based on a non-functional requirement; implemented function group storing means for storing information on a group of combinable implemented functions based on the non-functional requirement; service logical model describing means for creating information on a service logical model for satisfying the non-functional requirement; program group generating means for generating a program group which realizes the service logical model based on information on the service logical model, and which includes the non-functional requirement and the group of combinable implemented functions based on the information on the group of combinable implemented functions; non-functional requirement storing means for storing the service non-functional requirement information; program group storing means for storing the program group; execution program configuring means for interpreting the non-functional requirement and selecting the group of combinable implemented functions to configure an execution program from the program group; and service executing means for executing the execution program.

According to still another aspect of this invention, there is provided a program for building and managing a Web service, program causing a computer to function as: service non-functional requirement describing means for creating service non-functional requirement information based on a non-functional requirement; implemented function group storing means for storing information on a group of combinable implemented functions based on the non-functional requirement; service logical model describing means for creating information on a service logical model for satisfying the non-functional requirement; program group generating means for generating a program group which realizes the service logical model based on the information on the service logical model, and which includes the non-functional requirement and the group of combinable implemented functions based on the information on the group of combinable implemented functions; non-functional requirement storing means for storing the service non-functional requirement information; program group storing means for storing the program group; execution program configuring means for interpreting the non-functional requirement and selecting the group of combinable implemented functions to configure an execution program from the program group; and service executing means for executing the execution program.

### Effect of the Invention

According to this invention, it is possible to provide, to persons who engage in building systems, a method, device, and program for building a Web service, which is capable of building a system that satisfies performance and other system requirements even in a situation where the magnitude of increase and the degree of change in the amount of data to be handled cannot be predicted at the time the system is designed.

According to this invention, it is also possible to provide, to persons who engage in operating systems, a method, device, and program for managing a Web service, which is capable of providing steady operation for a system implemented under the situation described above.

### BRIEF DESCRIPTION OF THE DRAWING

FIG. 1 is a functional block diagram of a Web service building/managing device 100 according to an embodiment mode of this invention.

FIG. 2 is a diagram illustrating an example of a service non-functional requirement list.

FIG. 3 is a diagram illustrating an example of service non-functional requirement information.

FIG. 4 is a diagram illustrating an example of a service logical model describing portion.

FIG. 5 is a flow chart illustrating the operation of the Web service building/managing device 100.

FIG. 6 is a functional block diagram of a Web service building/managing device 300 according to the embodiment mode of this invention.

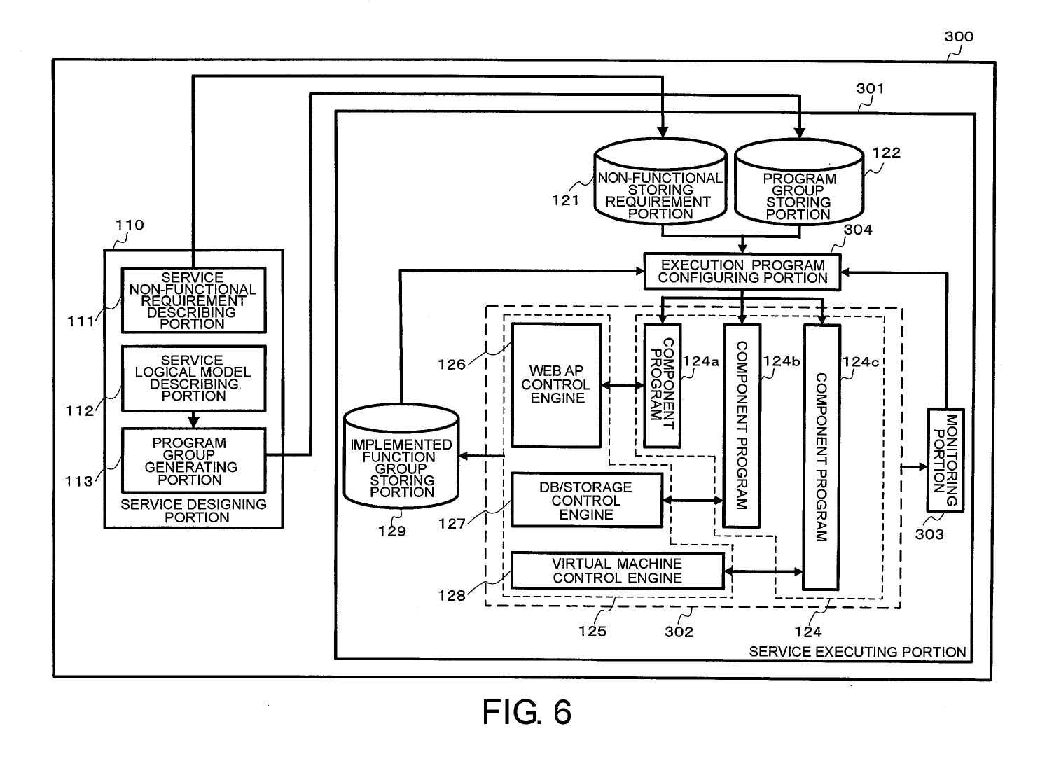

FIG. 7 is a flow chart illustrating the operation of the Web service building/managing device 300.

### BEST MODE FOR EMBODYING THE INVENTION

This invention is described further through a concrete description.

A Web service building/managing device of this invention is designed in anticipation of cases where the amount of data such as requests to a Web service system, data to be processed, and data to be kept increases explosively while the system is in operation. Against the background of the recent need for cloud computing, such a situation means increasing the number of computer nodes that perform processing and switching storage while the system is in operation.

Unlike server clustering which involves connecting a plurality of servers, this invention has a system stack configuration in which an application server layer, a database layer, a storage layer, a virtual machine layer (CPU core count allocation), and the like are generated in a single server in a vertical direction.

When building a Web service building/managing system as one in this invention, performance requirements such as the number of transactions processed per unit time are described as non-functional requirements regarding availability, performance, security, and the like at the time the system is designed.

This invention is further configured to generate programs that are suited to respective system configurations such as a single-server configuration, a system configuration with a changed CPU allocation, and a system configuration that uses distributed storage, within the limit of allowable system configuration change.

A hardware resource used in this invention is a computer device, which includes a CPU serving as a computing device and a control device, a main memory such as a RAM, an auxiliary storage device such as an HDD, an input device, a display device, and an interface which are connected to one another via a data bus line. This invention can use any computer device as long as the computer device is connected to the Internet or the like via a telecommunication line.

Now, an embodiment mode of this invention is described with reference to the drawings.

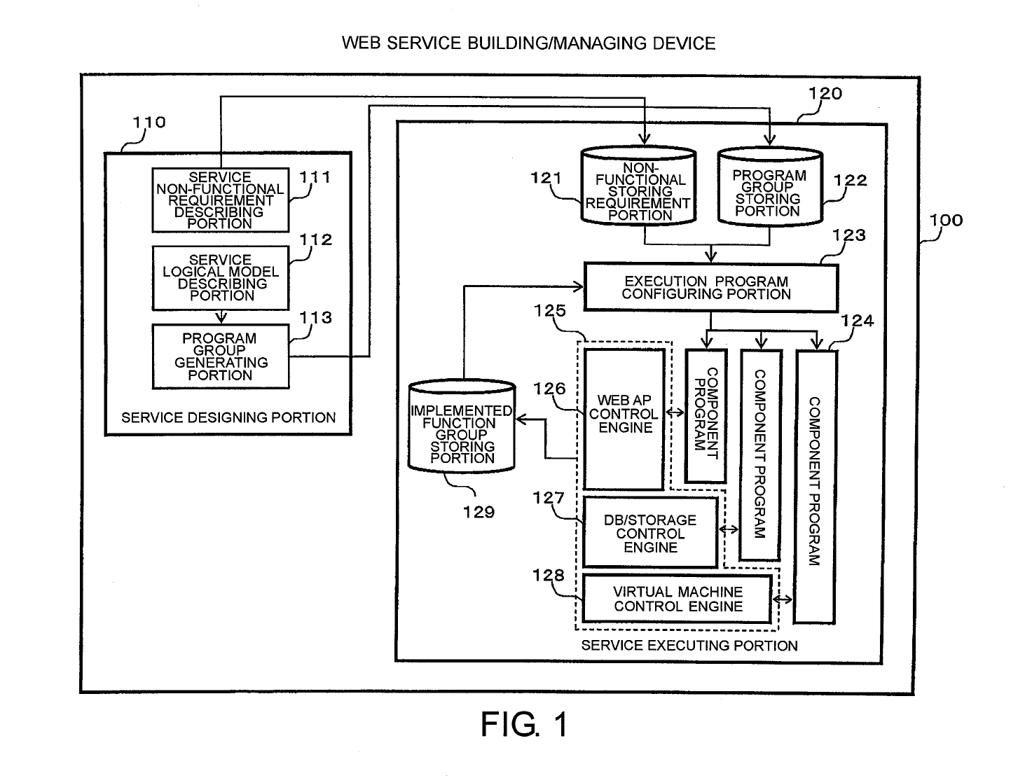

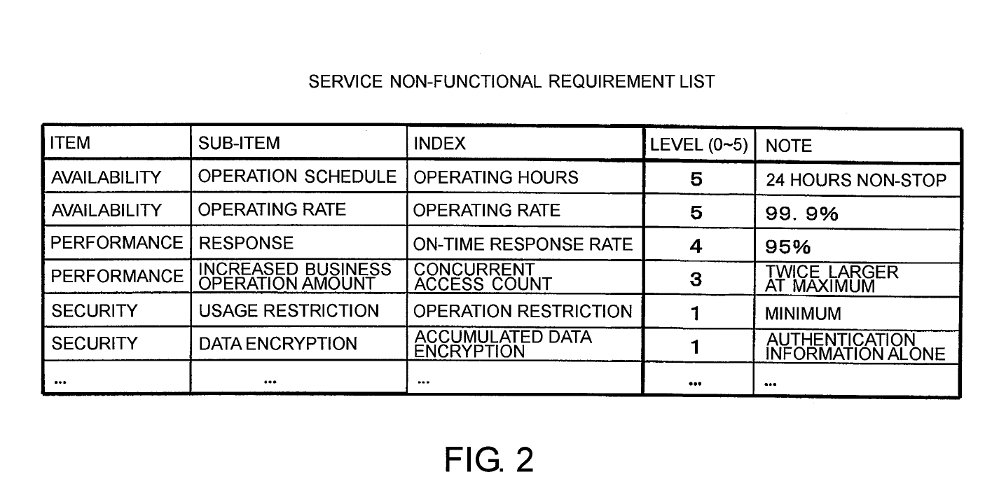

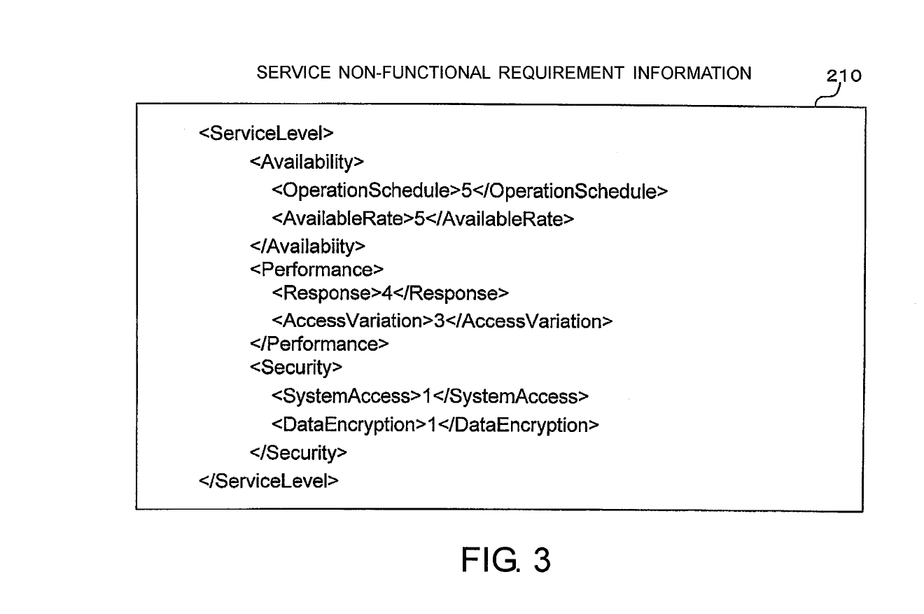

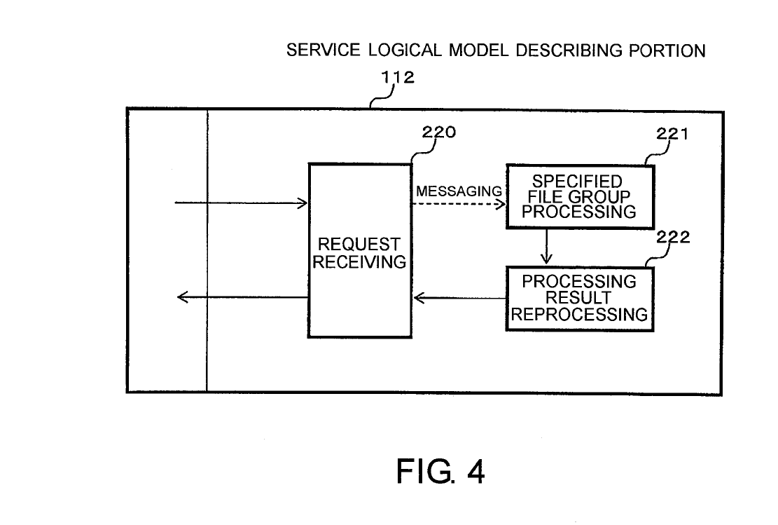

FIG. 1 is a block diagram illustrating the schematic configuration of a Web service building/managing device 100 according to an embodiment mode of this invention. FIG. 2 is a diagram illustrating an example of a service non-functional requirement list. FIG. 3 is a diagram illustrating an example of service non-functional request information. FIG. 4 is a diagram illustrating an example of a service logical model describing portion.

Referring to FIG. 1, the Web service building/managing device 100 includes a service designing portion 110 and a service executing portion 120.

The service designing portion 110 includes a service non-functional requirement describing portion 111, a service logical model describing portion 112, and a program group generating portion 113.

The service non-functional requirement describing portion 111 is provided to allow a service designer to enter a requirement level value of each non-functional requirement item to a service non-functional requirement list illustrated in FIG. 2, and to convert the value into service non-functional requirement information structured as illustrated in FIG. 3.

The service logical model describing portion 112 includes, as illustrated in FIG. 4, a request receiving portion 220 for receiving a request, a specified file group processing portion 221 for processing a specified file group, and a processing result reprocessing portion 222 for reprocessing a processing result, and is configured in a manner that allows the service designer to write the flow of requests to a Web server and the flow of processing within the server. The service logical model describing portion 112 creates service logical model information 220, which is information input to the program group generating portion 113.

The program group generating portion 113 generates a source code of a Web application to be implemented in a logical model, based on service logical model information (discussed later) described in the service logical model describing portion 112 and implemented function group information stored in an implemented function group storing portion 129 (discussed later).

The source code includes a plurality of source codes conformed to the OSI network layer, such as a source code for a Web application control level, a source code for a Web application server control level, and a source code for an OS control level of an OS that runs a Web application server.

The service executing portion 120 includes a non-functional requirement storing portion 121, a program group storing portion 122, an execution program configuring portion 123, a plurality of component programs 124 configured by the execution program configuring portion 123, a service executing engine 125 which executes the respective component programs 124, and the implemented function group storing portion 129.

The non-functional requirement storing portion 121 stores non-functional requirement information 210 created by the service non-functional requirement describing portion 111 of the service designing portion 110.

The implemented function group storing portion 129 stores information of a group of installed functions that can be combined for a service non-functional requirement.

The program group storing portion 122 stores programs generated by the program group generating portion 113.

When a Web service is executed, the execution program configuring portion 123 determines the respective component programs 124 with the use of service non-functional requirement information stored in the non-functional requirement storing portion 121, a program group stored in the program group storing portion 122, and system load information, such as CPU utilization rate, network band occupation rate, file TO frequency, obtained from a computer that runs the service executing portion 120. The execution program configuring portion 123 also selects and determines a group of implemented functions that can be combined, for example, engines stored in the service executing engine, when a service non-functional requirement is executed.

The service executing engine 125 includes a Web AP control engine 126 for executing a

Web application, a DB/storage control engine 127 for managing a database and file storage, a virtual machine control engine 128 for controlling an OS virtual machine, and the like.

The component programs 124 disposed in the service executing portion 120 are executed by, for example, the associated Web AP control engine 126, DB/storage control engine 127, and virtual machine control engine 128.

With the thus configured Web service building/managing device 100, a system that satisfies performance and other system requirements can be built in a situation where the magnitude of increase and the degree of change in the amount of data to be handled cannot be predicted at the time the system is designed.

The Web service building/managing device 100 also makes steady operation possible for a system that is implemented under the situation described above.

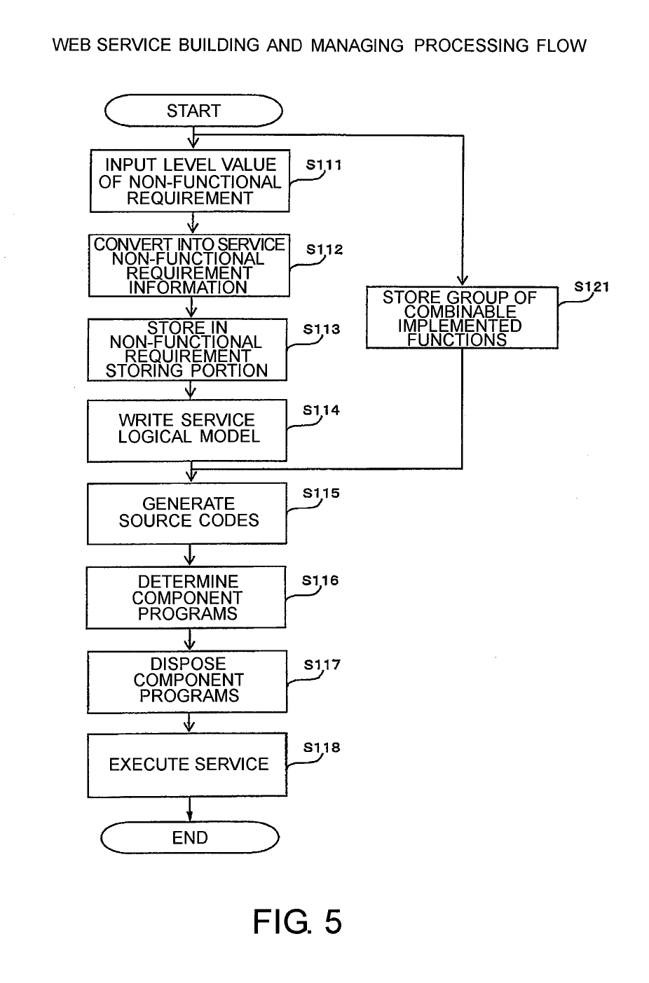

The operation of the Web service building/managing device 100 is described next with reference to a flow chart of FIG. 5.

FIG. 5 is a diagram illustrating a Web service building and managing processing flow. Referring to FIG. 5, in analyzing requirements that are presented by a service user, the service designer enters a requirement level value of each individual non-functional requirement item to the service non-functional requirement list of FIG. 2 through the service non-functional requirement describing portion 111 (Step S111). This information is converted into the structured service non-functional requirement information of FIG. 3 (Step S112), and is stored in the non-functional requirement storing portion 121 (Step 113).

During the requirement analysis, in parallel with Step S111, a group of implemented functions that can be combined is stored in the implemented function group storing portion 129 (Step S121).

The service designer next writes, as a schematic design of the Web service, in the service logical model describing portion 112 of FIG. 4, the flow of requests to a Web server and the flow of processing within the server (Step S114). Based on the service logical model information 210 which is described in the service logical model describing portion 112 and a group of combinable implemented functions which is stored in the implemented function group storing portion 129, the program group generating portion 113 generates a source code of a Web application to be implemented in a logical model (Step S115). The source code generated in this step (Step S115) is a plurality of source codes conformed to the OSI network layer, such as a source code for a Web application control level, a source code for a Web application server control level, and a source code for an OS control level of an OS that runs a Web application server. The generated programs are stored in the program group storing portion 122 (Step S116).

When the Web service is executed, the execution program configuring portion 123 determines the component programs 124 with the use of service non-functional requirement information stored in the non-functional requirement storing portion 121, a program group stored in the program group storing portion 122, and system load information, such as CPU utilization rate, network band occupation rate, and file IO frequency, obtained from a computer that runs a group of combinable implemented functions stored in the implemented function group storing portion 129 and including the Web AP control engine 126, the DB/storage control engine 127, and the virtual machine control engine 128, and that runs the service executing portion 120 (Step 116). The execution program configuring portion 123 further disposes these component programs in the service executing portion 120 (Step 117).

The disposed component programs are executed by the Web AP control engine 126, the DB/storage control engine 127, the virtual machine control engine 128, and the like (Step 118).

In the form of the thus configured Web service building/managing device 100, this invention provides a Web service building/managing device capable of building a system that satisfies performance and other system requirements in a situation where the magnitude of increase and the degree of change in the amount of data to be handled cannot be predicted at the time the system is designed.

The provided Web service building/managing device also makes steady operation possible for a system that is implemented under the situation described above.

According to the embodiment mode of this invention, the Web service building/managing method has a function of automatically generating codes for controlling a program, storage, and a virtual machine that satisfy non-functional requirements, and therefore eliminates the need to consider the physical structure at the time of logical design. This invention thus provides a method, device, and program for managing a Web service, which allows a service designer to concentrate on logical design of a Web service.

Further, according to the embodiment mode of this invention, a program for controlling the Web application layer, a program for controlling the storage layer, and a program for controlling the virtual machine layer are generated in advance at the time a Web service is designed, which makes it possible to change the configuration of an execution program on a plurality of layers when the Web service is executed. This invention thus provides a method, device, and program for managing a Web service, which can flexibly deal with a rapid increase or decrease in data when the service is in operation.

In particular, according to the embodiment mode of this invention, a provider of cloud services such as SaaS and IaaS who provides service functions of a Web service function layer, a Web service platform layer, and an operating system layer can provide a highly scalable service platform suited to a user's non-functional requirements by combining services of the SaaS, PaaS, and IaaS layers. Moreover, provided with this service platform, a designer/implementor of a Web service no longer needs to consider a service platform and can concentrate on the development of business operation logic alone.

### FIRST EMBODIMENT

A first embodiment of this invention is described next in detail with reference to FIG. 1 and FIG. 3.

What is envisioned in embodiments of this invention is the development of a system for collecting information posted on news sites, blogs, and the like on the Web and analyzing consumer trends.

Non-functional requirements of this Web application in terms of response performance include a response time of 3 seconds or less and an on-time response rate of 95%.

At the time of requirement analysis, these requirements are written as the service non-functional requirement information 210 in the service non-functional requirement describing portion 111 of FIG. 1 and stored in the non-functional requirement storing portion 121. The on-time response rate of a performance item is set here to Level 4, which corresponds to an on-time response rate of 95%.

A Web service is designed next. The Web application periodically collects information of a plurality of pre-registered news sites and blogs, and accumulates the collected information in respective files.

Receiving a request from a user, the Web application uses the service logical model component 221 to perform processing of searching a specified file group for a particular letter string and counting hits, and uses the service logical model component 222 to perform processing of compiling results of the counting. The searching process, the counting processing and the compiling processing are described in the service logical model describing portion 112.

For each component of the service logical model information 220, the program group generating portion 113 generates an application level source code, for example, a Java (trademark) class source code in the case where an application server capable of executing Java programs is used for an execution platform. The program group generating portion 113 also generates a source code for accessing a database such as the implementation of a relational database or a key-value database.

Similarly, a storage level source code for controlling distributed storage and a source code for controlling the addition/removal of an OS virtual machine are generated. A group of these source codes is stored in the program storing portion 122.

When the Web service is put into operation, the execution program configuring portion 123 determines component programs in a manner that meets the service non-functional information with the use of the service non-functional information 210 stored in the non-functional requirement storing portion 121, programs stored in the program storing portion 122, and system load information, such as CPU utilization rate, network occupation rate, and file IO frequency, obtained from a computer that runs the service executing portion 120.

For example, in order to change the parallelism of application level program execution unit depending on whether the Web service execution environment has a single-core CPU or a multi-core CPU, a program for changing the program instance count is registered to the Web AP control engine. In the case where the load of file IO is heavy, a program for controlling distributed storage is registered to the DB/storage control engine.

In the case where the OS count itself is increased for scale-out, a program for controlling virtual machines is registered to the virtual machine control engine 128. The service executing engine 125 executes these registered programs.

### SECOND EMBODIMENT

A Web service building/managing device 300 according to a second embodiment of this invention is described next. In addition to the components of the Web service building/managing device 100 described above, the Web service building/managing device 300 has, in a service executing portion 301, a monitoring portion 303 for monitoring a service portion 302, which is constituted of the component programs 124 and the service executing engine 125. Components other than this are the same as those of the already described Web service building/managing device 100, and descriptions thereof are omitted.

The monitoring portion 303 periodically obtains, from a computer that runs the service executing portion 302, system load information such as CPU utilization rate, network band occupation rate, and file IO frequency, and compares against a predetermined upper limit value and lower limit value. When the system load rises above the upper limit value or drops below the lower limit value, the monitoring portion 303 requests an execution program configuring portion 304 to reconfigure an execution program.

The component programs 124 include component programs 124a, 124b, and 124c. The component programs 124a, 124b, and 124c have a hierarchical structure. The component program 124b is run above the component program 124c, and the component program 124a is run above the component program 124b.

The component program 124c is an operating system running as a virtual OS on the virtual machine control engine 128, specifically, UNIX, LINUX, Windows of Microsoft, or the like.

The component program 124b is an application program running on a virtual OS (the component program 124c), and accesses a physical drive device accessible to the Web service building/managing device 300 via the DB/storage control engine 127. The component program 124b is specifically a Web server program, for example, an Apache HTTP server or an Internet Information Server (IIS) of Microsoft.

The component program 124a is a Web application that runs in cooperation with an application program (the component program 124b), and is executed by the Web AP control engine 126, which is the execution environment of the component program 124a. The component program 124a is specifically an application program written in a computer language such as PHP: Hypertext Processor or Perl. The Web AP control engine 126 includes runtime, security, resource distribution, and other environment settings for running an application program written in a computer language.

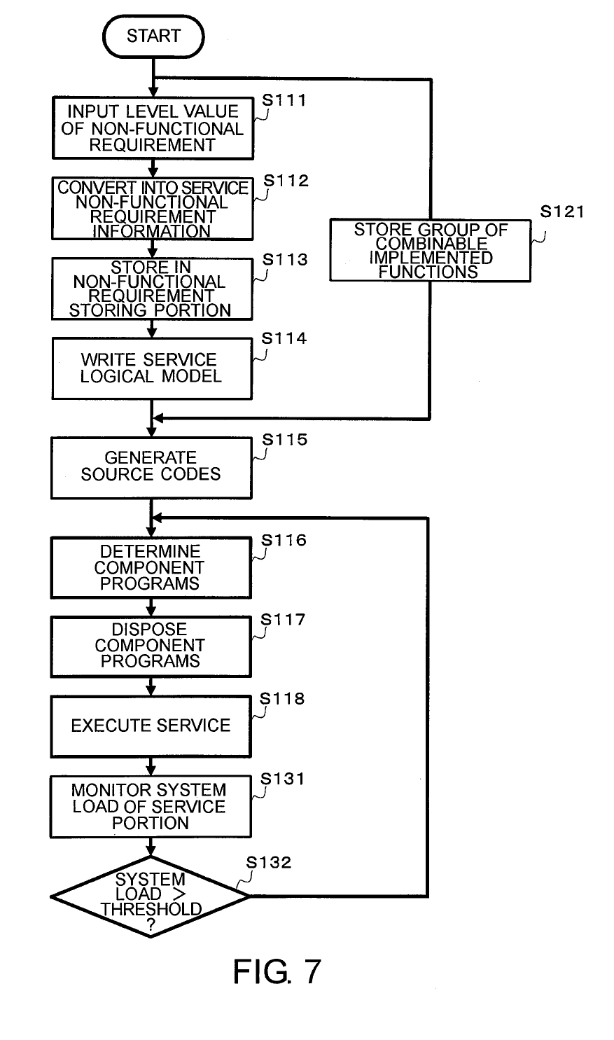

The operation of the Web service building/managing device 300 is described next with reference to FIG. 7. Steps S111 to S114 are the same as the already described steps.

In Step S115, the program group generating portion 113 generates a plurality of source codes conformed to the OSI network layer. The service executing portion 301 includes a plurality of Web control engines 126 associated with the Web application control level. For each of the plurality of Web AP control engines, the program group generating portion 113 generates a source code of a Web application program, namely, the component program 124a, that realizes, when executed on the Web AP control engine, a service logical model described in the service logical model describing portion 112. The program group generating portion 113 consequently generates a plurality of source codes corresponding to the plurality of Web AP control engines. A plurality of source codes may be generated for one Web AP control engine. For example, a plurality of source codes different from one another only in the number of clients that are allowed to access concurrently may be generated for the same Web AP control engine. The service executing portion 301 also includes a plurality of DB/storage control engines 127 associated with the Web application server control level. For each of the plurality of DB/storage control engines 127, the program group generating portion 113 generates a source code of a program that functions as the component program 124b in the DB/storage control engine 127. The program group generating portion 113 consequently generates a plurality of source codes corresponding to the plurality of DB/storage control engines 127.

The service executing portion 301 also includes a plurality of virtual machine control engines 128 associated with the OS control level of an OS that runs the Web application server. For each of the plurality of virtual machine control engines 128, the program group generating portion 113 generates a source code of a program that functions as the component program 124c in the virtual machine control engine 128. The program group generating portion 113 consequently generates a plurality of source codes corresponding to the plurality of virtual machine control engines 128.

After a plurality of source codes are generated on a control engine-by-control engine basis for the same service logical model and stored in the program group storing portion 122 in this manner, the execution program configuring portion 304 configures the component programs 124a, 124b, and 124c in Step S116, based on data stored in the non-functional requirement storing portion 121, data stored in the program group storing portion 122, data stored in the implemented function group storing portion 129, and the load information obtained by the monitoring portion 303.

The service executing portion 301 uses three control engines corresponding to three control levels to provide one Web service. The premise here is that the service executing engine 301 has two types of control engines for each control level as control engines that can be used to provide a Web service, and that one source code is stored for one control engine in the program group storing portion 122. There are 2×2×2=8 combinations of control engines used on the three control levels in this case. However, there are also combination restrictions, for example, the inability of a Web server to run on OSs other than a particular OS. Further, in the case where the program group storing portion 122 stores a plurality of source codes for one control engine, there may be restrictions on combination of source codes. These combination restrictions are stored in the implemented function group storing portion 129.

The execution program configuring portion 304 selects control engines and source codes to be used in a manner that meets restrictions on control engine combination and other combinations stored in the implemented function group storing portion 129, restrictions based on non-functional requirement information stored in the non-functional requirement portion 121, and restrictions on hardware resources available to the Web service which are based on the load information obtained by the monitoring portion 303. The execution program configuring portion 304 generates the component programs 124a, 124b, and 124c from the selected source codes.

In Step S117, these configured programs are disposed in a manner that enables the associated Web AP control engine 126, DB/storage control engine 127, and virtual machine control engine 128 to execute the programs. In Step S118, the respective disposed component programs are executed by their associated control engines to start providing the Web service.

The monitoring portion 303 continues monitoring the system load of the service portion 302 (Step S131) after the Web service starts to be provided. When the system load exceeds the given upper limit value (Step S132), the monitoring portion 303 requests the execution program configuring portion 304 to reconfigure the execution program. In response, the execution program configuring portion 304 executes Step S116 again.

For example, when the monitoring portion 303 detects that users of a Web service provided by the service portion 302 have increased in number and the frequency of access being denied due to restrictions on the number of clients that are allowed to access concurrently has exceeded a given figure, the execution program configuring portion 304 does not change the Web AP control engine 126 to be used but changes the associated component program 124a, to thereby increase or reduce the number of clients that are allowed to receive the Web service concurrently.

Alternatively, when the monitoring portion 303 detects that the free capacity of a storage area allocated to a database of a Web service has dropped below a given value as a result of an increase in the number of users of the Web service, the execution program configuring portion 304 changes the DB/storage control engine 127 and the component program 124b to change storage area allocation or to change or add an external storage device.

In the case where the monitoring portion 303 detects that CPU utilization rate has exceeded a given value, the execution program configuring portion 304 switches the component program 124c, namely, a virtual OS, to another OS that is light in system load, and accordingly changes the Web AP control engine 126 and the DB/storage control engine 127 based on viable combinations of the Web AP control engine 126, the DB/storage control engine 127, and the virtual machine control engine 128 which are stored in the implemented function group storing portion 129. These changes are accommodated by further changing the component programs 124a and 124b.

The premise of the description given above is that one Web service is provided on the same server hardware. However, it would be obvious to the skilled in the art that a plurality of service portions 302 could be concurrently provided on the same server hardware. When the monitoring portion 303 detects that the load of one of a plurality of concurrently provided Web services has exceeded a given value, the execution program configuring portion 304 may not only reconfigure an execution program relevant to this Web service but also reconfigure execution programs of the other Web services that are being provided concurrently. This way, the allocation of Web server hardware resources to the respective Web services is optimized in accordance with the processing loads of the Web services.

Here, the system load is compared against an upper limit value in Step S132 and an execution program is reconfigured when the system load exceeds the upper limit value. Instead of the upper limit value, a lower limit value may be set in order to reconfigure an execution program when the system load is below the lower limit value.

### INDUSTRIAL APPLICABILITY

As has been described, a method, device, and program for building and managing a Web service according to this invention is applied to the providing of service functions of a Web service function layer, a Web service platform layer, and an operating system layer by providers who provide cloud services such as SaaS, PaaS, and IaaS.

This application claims priority from Japanese Patent Application No. 2010-024453, filed on Feb. 5, 2010, the entire disclosure of which is incorporated herein by reference.

1. A method of building and managing a Web service, comprising:
a service non-functional requirement describing step of creating service non-functional requirement information based on a non-functional requirement;
an implemented function group storing step of storing information on a group of combinable implemented functions that can be combined based on the non-functional requirement;
a service logical model describing step of creating information on a service logical model for satisfying the requirement;
a program group generating step of generating a program group which realizes the logical model based on the logical model information, and which includes the non-functional requirement and the group of combinable implemented functions based on the information on the group of combinable implemented functions;
a non-functional requirement storing step of storing the service non-functional requirement information;
a program group storing step of storing the program group;
an execution program configuring step of interpreting the non-functional requirement and selecting the group of combinable implemented functions to configure an execution program from the program group; and
a service executing step of executing the execution program.

2. A method of building and managing a Web service according to claim 1, wherein, in the execution program configuring step, system load information such as a CPU utilization rate, a network band occupation rate, and a file 10 frequency is used to select a program stored in the program group storing step in a manner that satisfies the non-functional requirement, and to determine a component program.

3. A method of building and managing a Web service according to claim 1, wherein the program group generating step has a function of generating a program that realizes the information on the service logical model, for each of layers such as an application level, a DB/storage level, and an OS level.

4. A method of building and managing a Web service according to claim 1, wherein the execution program configuring step includes selecting a program that has been stored in the program group storing step in a manner that satisfies the non-functional requirement, and disposing programs of the group of combinable implemented functions in a service executing engine.

5. A device for building and managing a Web service, comprising:
service non-functional requirement describing means for creating service non-functional requirement information based on a non-functional requirement;
implemented function group storing means for storing information on a group of combinable implemented functions based on the non-functional requirement;
service logical model describing means for creating information on a service logical model for satisfying the requirement;
program group generating means for generating a program group which realizes the logical model based on the logical model information, and which includes the non-functional requirement and the group of combinable implemented functions based on the information on the group of combinable implemented functions;
non-functional requirement storing means for storing the service non-functional requirement information;
program group storing means for storing the program group;
execution program configuring means for interpreting the non-functional requirement and selecting the group of combinable implemented functions to configure an execution program from the program group; and
service executing means for executing the execution program.

6. A device for building and managing a Web service according to claim 5, wherein the execution program configuring means uses system load information such as a CPU utilization rate, a network band occupation rate, and a file TO frequency to determine a component program in a manner that satisfies the non-functional requirement, or to select a program stored in the program group storing means in a manner that satisfies the non-functional requirement and dispose programs of the group of combinable implemented functions in a service executing engine.

7. A device for building and managing a Web service according to claim 5, wherein the program group generating means generates a program that realizes the information on the service logical model, for each of layers such as an application level, a DB/storage level, and an OS level.

8. A program for building and managing a Web service, the program causing a computer to function as:
service non-functional requirement describing means for creating service non-functional requirement information based on a non-functional requirement;
implemented function group storing means for storing information on a group of combinable implemented functions based on the non-functional requirement;
service logical model describing means for creating information on a service logical model for satisfying the requirement;
program group generating means for generating a program group which realizes the logical model based on the logical model information, and which includes the non-functional requirement and the group of combinable implemented functions based on the information on the group of combinable implemented functions;
non-functional requirement storing means for storing the service non-functional requirement information;
program group storing means for storing the program group;
execution program configuring means for interpreting the non-functional requirement and selecting the group of combinable implemented functions to configure an execution program from the program group; and
service executing means for executing the execution program.

9. A program for building and managing a Web service according to claim 8, wherein the program group generating means has a function of generating a program that realizes the information on the service logical model, for each of layers such as an application level, a DB/storage level, and an OS level.

10. A program for building and managing a Web service according to claim 8, wherein the execution program configuring means has a function of selecting a program that has been stored in a program group storing step in a manner that satisfies the non-functional requirement, and automatically disposing the program in a service executing engine.

11. A method of building and managing a Web service according to claim 1, wherein, after the service executing step, a value relevant to system load information, which includes at least one of a CPU utilization rate, a network band occupation rate, and a file I/O frequency, is monitored and, depending on a result of comparison of the value against a predetermined threshold, the execution program configuring step and the service executing step are executed again based on the system load information that has been used in the comparison.

12. A device for building and managing a Web service according to claim 6, further comprising means for comparing, against a predetermined threshold, a value relevant to the system load information that has been obtained while the service executing means is executing the execution program,
wherein, depending on a result of the comparison, the execution program configuring means and the service executing means are executed again based on the system load information that has been used in the comparison.

13. A program for building and managing a Web service according to claim 8, further causing the computer to function as means for comparing, against a predetermined threshold, a value relevant to system load information that has been obtained while the service executing means is executing the execution program,
wherein, depending on a result of the comparison, the execution program configuring means and the service executing means are executed again based on the system load information that has been used in the comparison.
